(19) United States
(12) Patent Application Publication
(10) Pub. No.: US 2006/0104322 A1
(43) Pub. Date: May 18, 2006

(54) Temperature-independent external cavity laser

(76) Inventors: Mahn Yong Park, Daejeon (KR); Byoung Whi Kim, Daejoen (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/122,840

(22) Filed: May 4, 2005

(30) Foreign Application Priority Data
Nov. 18, 2004 (KR) 2004-94490

(51) Int. Cl. H01S 3/04

(52) U.S. Cl. 372/34

(57) ABSTRACT

Hybrid-type external cavity lasers designed to have a semiconductor laser diode mounted on a planar waveguide platform by a flip-chip bonding method. The temperature independent external cavity laser comprises a semiconductor laser diode, a planar waveguide platform, and a thin film multi-layered reflection filter. The semiconductor laser diode includes an active region to generate light, and at least one light-emitting surface. The planar waveguide platform includes a substrate, a metallic pattern formed on a predetermined region of the substrate, a waveguide structure, and a trench portion. The waveguide structure comprises a lower clad layer, a core, and an upper clad layer sequentially stacked in this order on a region of the substrate excluding the predetermined region formed of the metallic pattern. The trench portion has opposite side surfaces on which the core is exposed.

### RELATED APPLICATIONS

The present invention is based on, and claims priority from, Korean Application Number 2004-94490, filed Nov. 18, 2004, the disclosure of which is incorporated by reference herein in its entirety.

### BACKGROUND OF THE INVENTION

1. Field of the Invention

The present invention relates to hybrid-type external cavity lasers, designed to have a semiconductor laser diode mounted on a planar waveguide platform by a flip-chip bonding method, and, more particularly, to temperature independent external cavity lasers, designed to have a thin film multi-layered (TFML) reflection filter having reflection characteristics independent of temperature variation on a planar waveguide platform, and to provide an optical path constituted by cavities and having a total length, which is constant independent of the temperature variation.

2. Description of the Related Art

Recently, due to widespread application of digital home service systems, it has been predicted that an increased average bandwidth of 100 Mbps per subscriber will be required in near future, and in this case, fiber to the home (FTTH) technologies will gradually replace conventional digital subscriber line (DSL) technologies and cable modem technologies, which cannot provide a bandwidth of 50 Mbps or more. In order to realize the FTTH technologies, it is necessary to secure technologies for permitting an increase of the number of subscribers without significantly increasing an installation size of optical fibers, and technologies for realizing construction of optical cables to the subscribers at low costs to an extent of the conventional technology.

As an example of transmission methods for realizing the FTTH technologies, a wavelength division multiplexing-passive optical network (WDM-PON) system can provide an effect of increasing the number of optical fibers by the number of multiplexed wavelengths of laser by multiplexing a plurality of wavelengths of the laser to carry a plurality of optical signals on a single optical fiber. With such a construction, since the WDM-PON system can receive a plurality of signals from several subscribers in a single optical line, it enables cost reduction by means of reduction in construction costs of the cable line and by means of intensive management on a cable head-end, and provides an advantage in terms of security and protocol clarity by separation of subscriber traffic, through which the subscriber traffic is separated by allocation of optical channels having different wavelengths to respective subscribers.

FIG. 1 shows a conventional external cavity laser available to the WDM-PON system. As shown in FIG. 1, the conventional external cavity laser 10 has a hybrid type structure wherein a semiconductor laser diode 11 is mounted on a planar waveguide platform 12 by a flip-chip bonding method.

The planar waveguide platform 12 has a substrate 121, a lower clad layer 122, a core 123, and an upper clad layer 124 sequentially stacked in this order on the substrate 121, and has a region A for mounting the semiconductor laser 11 thereon using the flip-chip bonding method. FIG. 2 is a detailed vertical section view illustrating the construction of a planar waveguide platform 22 (denoted by reference numeral 12 of FIG. 1), and the planar waveguide platform 22 has a substrate 221, a lower clad layer 222, a core 223, and an upper clad layer 224 sequentially stacked in this order, in which the upper clad layer 224 is stacked on overall surfaces of the lower clad layer 222 and the core 223. The planar waveguide platform 22 is made of silica, and when forming the lower clad layer 222, the core 223, and the upper clad layer 224 with the silica, they are formed in the planar waveguide platform 22 such that the core 223 has a higher refractive index than that of the upper and lower clad layers 222 and 224 by adding different doping materials (B₂O₃, P₂O₅, GeO₂) to the respective layers.

Referring to FIG. 1 again, the region A to which the semiconductor laser diode 11 is flip-chip bonded can be formed by selectively removing a predetermined portion of the lower clad layer 122, the core 123, and the upper clad layer on the region A after stacking the lower clad layer 122, the core 123, and the upper clad layer on the substrate 121. Then, a metallic pattern, an alignment pattern, and the like are formed on the flip-chip bonded region A by a semiconductor photolithography process.

The semiconductor laser diode 11 consist of III-V or II-IV based semiconductor materials. The semiconductor laser diode 11 comprises an active region 113 in which light is generated, and an optical mode size converter 115 by which an optical spot size of the light generated from the active region 113 is increased. The active region 113 has multiple quantum wells installed therein, so that electrons and holes injected from an n-type electrode on the semiconductor chip substrate and a p-type electrode formed on the top surface are recombined in the multiple quantum wells, thereby generating light. The optical mode size converter 115 is provided in the waveguide by reducing the size of the waveguide in the vertical and/or horizontal directions, and acts to convert the optical spot size of the light generated from the active region 113.

The semiconductor laser 11 is welded to an upper surface of the flip-chip bonded region A on the planar waveguide platform 12 by use of a welding metal 13. In general, the welding metal 13 includes under bump metal (UMB), and a solder (Au/Sn). Upon flip-chip bonding, the welding metal 13 is heated to a temperature of about 280° C. or more, and fused, thereby allowing the semiconductor laser diode 11 to be welded to the substrate 121 of the planar waveguide platform 12.

Light generated from the active region 113 of the semiconductor laser diode 11 is optically coupled to a side surface 127 of the planar waveguide platform 12 through a light emission surface 117a of the semiconductor laser diode 11.

In order to achieve external resonance effect, the conventional external cavity laser 10 comprises a reflection filter 125 having a Bragg grating structure, which is formed in the waveguide core 123 by use of a phase-mask after providing a predetermined region of the waveguide core 123 in the planar waveguide platform 12 to have a photosensitive effect. With such a construction, the conventional external cavity laser 10 allows external resonance to be created in an optical path formed from a rear surface 117b of the semiconductor laser diode to the reflection filter 125 of the Bragg grating structure.

In order to remove variation of the optical path of the external cavity caused by variation in external temperature, the conventional external cavity laser 10 has a construction in which a silicon resin 126 having a specified thermo-optic coefficient is inserted between the reflection filter 125 of the Bragg grating structure and the side surface 127 of the planar waveguide platform within the planar waveguide platform 12.

In the conventional external cavity laser constructed as described above, since the reflection filter 125 of the Bragg grating structure is formed using the phase-mask, it is necessary to have a pretreatment process for providing the photosensitive effect to the waveguide core 123 before forming the Bragg grating structure. Moreover, due to the phase-mask, it is difficult to form the reflection filter 125 of the Bragg grating structure in an accurate location desired on the planar waveguide platform 12. Moreover, since the silicon resin 126 is inserted not to a waveguide region but to a free propagation region, additional insertion loss can be generated, and internal reflection can occur due to roughness of side surfaces 126a and 126b where the waveguide is removed, thereby reducing performance of the external cavity laser.

### SUMMARY OF THE INVENTION

The present invention has been made to solve the above problems, and it is an object of the present invention to provide a temperature independent external cavity laser, designed to have a thin film multi-layered (TFML) reflection filter as a reflector for obtaining external resonance instead of a reflection filter having a Bragg grating structure in order to control an oscillation wavelength irrespective of an external temperature.

It is another object of the present invention to provide the temperature independent external cavity laser, designed to have a waveguide structure in the planar waveguide platform, a thermal coefficient of constituent material, and a length of the waveguide structure set to have an optical path having a constant total length irrespective of variation in external temperature without inserting a silicon resin material.

In accordance with one aspect of the present invention, the above and other objects can be accomplished by the provision of a temperature independent external cavity laser, comprising: a semiconductor laser diode including an active region to generate light, and at least one light emitting surface to emit the light generated from the active region; a planar waveguide platform including a substrate, a metallic pattern formed on a predetermined region of the substrate, a waveguide structure, and a trench portion formed in a predetermined region of the waveguide structure, the waveguide structure having a lower clad layer, a core, and an upper clad layer sequentially stacked in this order on a region of the substrate excluding the predetermined region formed of the metallic pattern, the trench portion having opposite side surfaces on which the core is exposed; and a thin film multi-layered reflection filter disposed in the trench portion, wherein the semiconductor laser diode is flip-chip bonded to the metallic pattern such that the light emitting surface faces one side surface of the waveguide structure.

The semiconductor laser diode may further comprise an optical mode size converter between the active region and the light emission surface. The semiconductor laser diode may further comprise an antireflection film coated on one side of the light emission surface, and a high-reflection film formed on the other side of the light emission surface opposite to the antireflection film. The waveguide structure may consist of a polymeric material.

The thin film multi-layered reflection filter may comprise a plurality of metal oxide films consisting of two types of metal oxide films and alternately stacked on a glass or polymer-based substrate. The thin film multi-layered reflection filter may have a variation rate of 3 pm/° C. or less at a central reflection wavelength according to variation in external temperature. The metal oxide films may consist of two types of metal oxide films selected from the groups consisting of SiO₂, Al₂O₃, Ta₂O₅ and TiO₂. The glass or polymer-based substrate may have a thickness of 50 μm or less.

The waveguide structure may further comprises an epoxy material filled between side surfaces of the trench portion and the thin film multi-layered reflection filter, and the epoxy material may be selected from the group consisting of a thermosetting epoxy material, an ultraviolet cured epoxy material, and the combination thereof. The difference between an effective refractive index of the epoxy material and that of the core of the planar waveguide platform may be 0.1 or less.

The waveguide structure may have an optical waveguide from one side of the planar waveguide platform facing the light-emitting surface to the thin film multi-layered reflection filter, and the optical waveguide may have a length determined according to the following Equation 1:

$${L}_{wg} = - \frac{( \frac{Δ {n}_{LD}}{Δ T} )}{( \frac{Δ {n}_{wg}}{Δ T} )} {L}_{LD} \qquad 1$$

In which L_{wg} is a length of the optical waveguide from the side of the planar waveguide platform facing the light-emitting surface to the thin film multi-layered reflection filter; Δn_{LD}/ΔT is a variation rate in refractive index of the semiconductor laser diode according to temperature variation; Δn_{wg}/ΔT is a variation rate in effective refractive index of the waveguide structure according to temperature variation; and L_{LD} is a length of the semiconductor laser diode.

The planar waveguide platform may consist of a polymeric material, the Δn_{wg}/ΔT value of which is in the range of −0.7×10⁻⁴ to −2.2×10⁻⁴/° C.

The temperature independent external cavity laser diode may have a groove formed on the other side opposite to one side of the planar waveguide platform facing the semiconductor laser diode to connect an optical fiber.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a transverse sectional view illustrating a conventional external cavity laser;

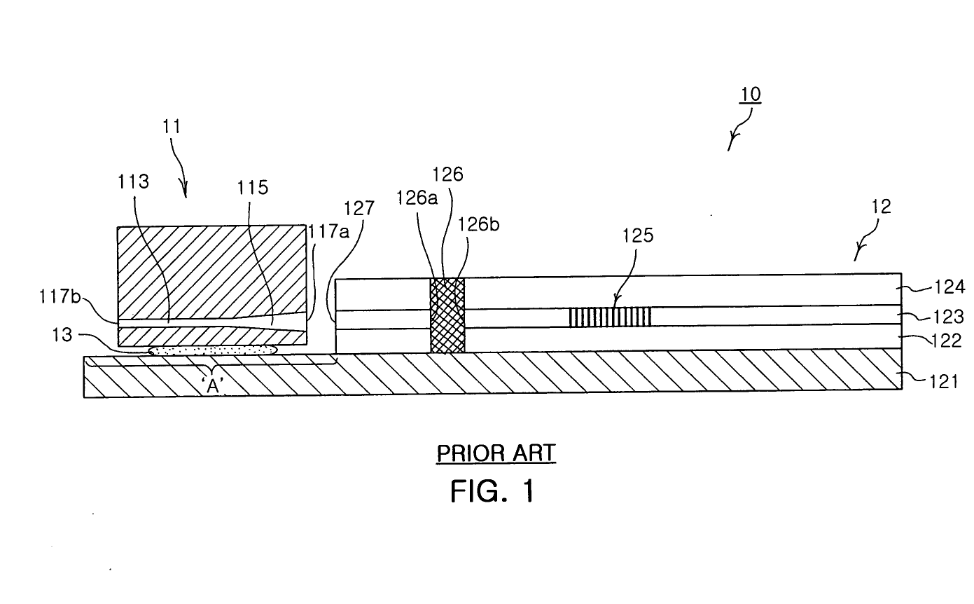

FIG. 2 is a longitudinal sectional view illustrating a general planar waveguide platform;

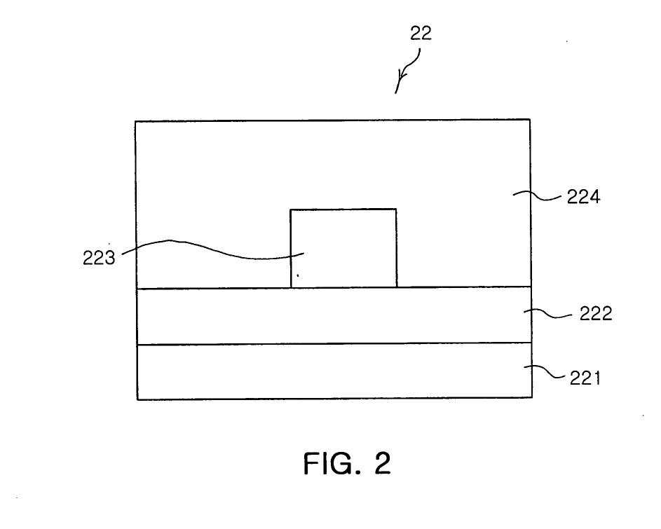

FIG. 3 is a transverse sectional view illustrating a temperature independent external cavity laser in accordance with one embodiment of the present invention;

FIG. 4 is a graphical representation illustrating reflection spectrum of a thin film multi-layered reflection filter in accordance with one embodiment of the present invention;

FIG. 5 is a graphical representation illustrating variation in effective refractive index of a waveguide structure consisting of a polymer material in accordance with temperature variation; and

FIGS. 6a and 6b are a transverse sectional view and a cross-sectional view illustrating a temperature independent external cavity laser in accordance with another embodiment of the present invention.

### DESCRIPTION OF THE PREFERRED EMBODIMENTS

Preferred embodiments will now be described in detail with reference to the accompanying drawings.

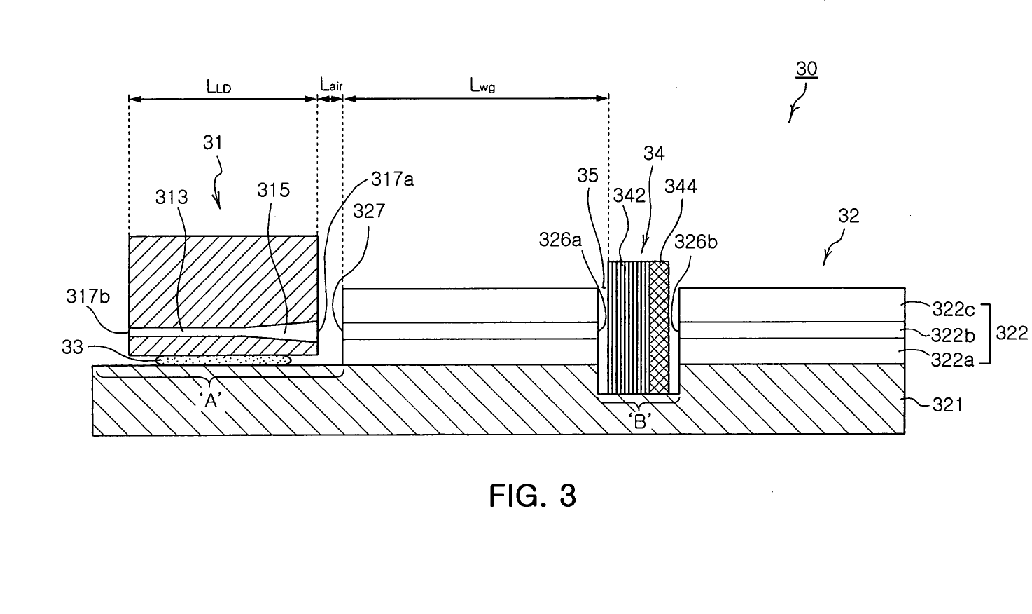

FIG. 3 is a transverse sectional view illustrating a temperature independent external cavity laser in accordance with one embodiment of the present invention. Referring to FIG. 3, a temperature independent external cavity laser 30 of the present invention comprises: a semiconductor laser diode 31 including an active region 313 to generate light, and at least one light emitting surface 371a to emit the light generated from the active region 313; a planar waveguide platform 32 including a substrate 321, a metallic pattern 33 formed on a predetermined region A of the substrate 321, a waveguide structure 322, and a trench portion 35 formed in a predetermined region B of the waveguide structure 322, in which the waveguide structure 322 comprises a lower clad layer 322a, a core 322b, and an upper clad layer 322c sequentially stacked in this order on a region of the substrate 321 excluding the predetermined region A formed of the metallic pattern 33, and in which the trench portion 35 has opposite side surfaces 326a and 326b on which the core is exposed in the predetermined region B of the waveguide structure 322; and a thin film multi-layered reflection filter 34 disposed in the trench portion 35.

In the temperature independent external cavity laser 30, the semiconductor laser diode 31 is flip-chip bonded to the metallic pattern 33 such that the light emitting surface 31 of the semiconductor laser diode 31 faces one side surface 327 of the waveguide structure 322 on which the core 322b is exposed.

Since the temperature independent external cavity laser 30 in accordance with the present invention is mainly used as an optical source for optical communication, the semiconductor laser diode 31 is preferably a semiconductor laser having a planar buried hetero-junction structure, which allows high-speed modulation. The semiconductor laser of the planar buried hetero-junction structure has current shielding layers formed on a side surface of the active layer formed between the clad layers, and prevents electric current from spreading upon operation, thereby providing advantages of a lower oscillation starting current, a higher quantum efficiency, and higher temperature characteristics.

The semiconductor laser diode 31 further comprises an optical mode size converter 315, which converts an optical spot size of light generated from the active region 313, and then outputs the converted light to the light emitting surface 317a. The optical mode size converter 315 is formed in order to allow effective optical coupling between the semiconductor laser diode 31 and the planar waveguide platform 72 (more specifically, the waveguide structure). The optical mode size converter 315 is formed next to the active region 313, and manufactured as lateral down tapers formed by gradually reducing a width of the waveguide defined within the active region 313, as vertical down tapers formed by gradually reducing a height of the waveguide, or as an appropriate combination thereof.

Then, an antireflection film (not shown) is formed on the light emission surface 317a of the semiconductor laser diode 31 in order to increase light extraction efficiency by preventing light from being reflected into the semiconductor laser diode 31. A high-reflection film (not shown) is formed on the other side surface 317b opposite to the light emitting surface 317a in order to increase amounts of the light emitted to the light emitting surface 317a.

The planar waveguide platform 32 includes a substrate 321, the metallic pattern 33 formed on the predetermined region A of the substrate 321, the waveguide structure 322, and the trench portion 35 formed on the predetermined region B of the waveguide structure 322, in which the waveguide structure 322 comprises the lower clad layer 322a, the core 322b, and the upper clad layer 322c sequentially stacked in this order on the region of the substrate 321 excluding the predetermined region A formed of the metallic pattern 33, and in which the trench portion 35 has opposite side surfaces 326a and 326b on which the core 322b is exposed in the predetermined region B of the waveguide structure 322.

The substrate 321 may consist of a semiconductor material, such as silicon. The waveguide structure 322 formed on the substrate 321 may consist of a polymeric material having a negative thermo-optical coefficient, of which refractive index is decreased as a temperature is increased. In the case where the waveguide structure 322 consists of the polymeric material, the planar waveguide platform 32 is preferably formed in such a manner that, after the metallic pattern 33 is first formed on the substrate 321, the lower clad layer 322a, the core 322b, and the upper clad layer 322c are sequentially deposited on the substrate 221, followed by selectively etching the predetermined region A of the lower clad layer 322a, the core 322b, and the upper clad layer 322c in a dry etching method such that the metallic pattern 33 is exposed.

The metallic pattern 33 includes under bump metal (UMB), and a solder (Au/Sn). Upon flip-chip bonding, the metallic pattern 33 is heated to a temperature of about 280° C. or more, and fused, thereby allowing the semiconductor laser diode 31 to be welded to the substrate 321 of the planar waveguide platform 32.

In the embodiment illustrated in FIG. 3, although the metallic pattern 23 is formed on the region A for flip-chip bonding, the present invention is not limited to this construction. Instead, it is apparent to those skilled in the art that the flip-chip bonding region A may be varied according to implementation of the present invention.

The planar waveguide platform 32 has the trench portion 35 formed in the predetermined region B of the waveguide structure 322. The trench portion 35 is formed to provide a space for disposing the thin film multi-layered reflection filter 34 therein. The trench portion 35 may be formed therein by removing some portion of the upper clad layer 322c, the core 322b, and the lower clad layer 322a corresponding to the predetermined region of the waveguide structure 322 by use of a half-dicing method using a dicing saw or by use of a dry etching method. The trench portion 35 is formed to a predetermined depth such that the core 322b can be exposed to opposite side surfaces of the trench portion 35.

The thin film multi-layered reflection filter 34 is disposed in the trench portion 35 formed in the waveguide structure 322 of the planar waveguide platform 32. The thin film multi-layered reflection filter 34 comprises a plurality of metal oxide films 342, which consist of two types of metal oxide films and are alternately stacked on a glass or polymer-based substrate 344. The thin film multi-layered reflection filter 34 may have a variation rate of 3 pm/° C. or less at a central reflection wavelength according to variation in external temperature to provide temperature independence.

In order to assure that the thin film multi-layered reflection filter 34 allows the center of the reflected wavelength to be independent of the variation in external temperature, the manufacturing process of the thin film multi-layered reflection filter 34 must be appropriately controlled. In the manufacturing process of the thin film multi-layered reflection filter 34, the thin film multi-layered reflection filter 34 is formed by alternatively stacking the plurality of metal oxide films 342, which consist of two types of metal oxide films having different refractive indexes and thicknesses, on the glass or polymer-based substrate 344 through a well-known deposition process, such as an ion deposition process, an E-beam deposition process, or a sputtering process. Upon such a high temperature deposition process, if the deposition process is performed using a deposition material (metallic oxide) having a high density equal to or greater than a predetermined level, the thin film multi-layered reflection filter 34 can be manufactured to have the temperature independent property of the variation rate of 3 pm/° C. or less at the central reflection wavelength according to variation in external temperature.

The substrate 344 of the thin film multi-layered reflection filter 34 may consist of the glass or polymer-based material, and may have a thickness of 50 μm or less under the consideration of optical loss upon optical coupling between the substrate 344 and the side surfaces 326a and 326b of the trench portion 35 having the thin film multi-layered reflection filter 34 disposed therebetween.

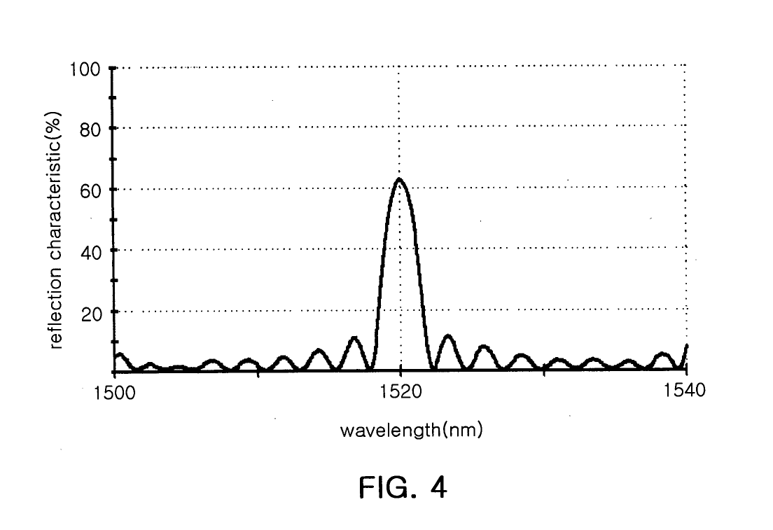

The plurality of metallic oxide films 342 formed on the substrate 344 of the thin film multi-layered reflection filter 34 is formed by alternately stacking two types of metal oxide film. The two types of metal oxide film may be selected from the groups consisting of SiO₂, Al₂O₃, Ta₂O₅ and TiO₂. For example, the thin film multi-layered reflection filter 34 may be manufactured by alternately stacking SiO₂ and Al₂O₃ thin films on the glass or polymer-based substrate 344 to eighty-seven thin film layers. The reflection spectrum of the thin film multi-layered reflection filter 34 is illustrated in FIG. 4. Referring to FIG. 4, it can be seen that the thin film multi-layered reflection filter 34 manufactured by alternately stacking the SiO₂ and Al₂O₃ thin films on the glass or polymer-based substrate 344 to the eighty-seven thin film layers has a desired reflection characteristic of 60% or more at a central wavelength of 1,520 nm. The reflection bandwidth, the central reflection wavelength, the reflection factor of the thin film multi-layered reflection filter 34 can be controlled if necessary by appropriately determining the kind, the thickness, and the number of laminations of the metallic oxide films 342.

Preferably, an epoxy material is filled between the side surfaces 326a and 326b of the trench portion 35 and the thin film multi-layered reflection filter 34 in order to fix the thin film multi-layered reflection filter 34. The epoxy material may be selected from the group consisting of a thermosetting epoxy material, an ultraviolet cured epoxy material, and the combination thereof. At this time, for a refractive index-matching, the epoxy material preferably has an effective refractive index in the range of 1.3˜1.7 for an optical communication wavelength in the range of 1,260˜1,650 nm, and most preferably, the difference between the effective refractive index of the epoxy material and that of the core 322b is 0.1 or less.

In the temperature independent external cavity laser 30 constructed as described above, an optical path where the resonance occurs is defined from the side surface 317b of the semiconductor laser diode 31 opposite to the light-emitting surface 317a of the semiconductor laser diode 31 to the upper surface of the thin film multi-layered reflection filter 34. The optical path where the resonance occurs can be expressed according to the following equation 2:
nLₜₒₜₐₗ(T)=n_{LD}(T)·L_{LD}+nₐᵢᵣ·Lₐᵢᵣ+n_{wg}(T)·L_{wg} 2

In Equation 2, n_{LD} is a refractive index of the semiconductor laser diode 31; L_{LD} is a length of the semiconductor laser diode 31; nₐᵢᵣ is a refractive index of an air gap between the semiconductor laser diode 31 and the waveguide structure 322; Lₐᵢᵣ is a length of the air gap; n_{wg} is an effective refractive index of the waveguide structure 32; and L_{wg} is a length of the waveguide from the one side 327 of planar waveguide platform facing the light emitting surface 317a of the semiconductor laser diode 31 to the thin film multi-layered reflection filter 34 (i.e., a length of the optical path where the resonance occurs).

In Equation 2, variation in a physical length of the optical path caused by variation in strain of the material according to the temperature is ignored since its effect is one one-hundredth that of the thermo-optical effect. Moreover, since the absolute value of the refractive index is meaningless while the variation of the refractive index according to the variation of the external temperature is important in the case of the temperature independent optical path, dispersion effect is also ignored.

From the Equation 2, the variation in length of the optical path caused by a variation ΔT of the external temperature is derived as represented by the following Equation 3:

$$\frac{Δ ( {nL}_{total} )}{Δ T} = \frac{Δ {n}_{LD}}{Δ T} {L}_{LD} + \frac{Δ {n}_{wg}}{Δ T} {L}_{wg} \qquad 3$$

In Equation 3, even if the variation in the external temperature occurs, the left side of the equation must be zero in order to provide a constant total length of the optical path where the resonance occurs. Accordingly, Equation 1 is derived as follows by rearranging the terms of the right side of the Equation 3.

$${L}_{wg} = - \frac{( \frac{Δ {n}_{LD}}{Δ T} )}{( \frac{Δ {n}_{wg}}{Δ T} )} {L}_{LD} \qquad 1$$

In which L_{wg} is a length of the optical waveguide (i.e., a length of the optical path where the resonance occurs) from the side of the planar waveguide platform facing the light-emitting surface to the thin film multi-layered reflection filter; Δn_{LD}/ΔT is a variation rate in refractive index of the semiconductor laser diode according to temperature variation; Δn_{wg}/ΔT is a variation rate in effective refractive index of the waveguide structure according to temperature variation; and L_{LD} is a length of the semiconductor laser diode.

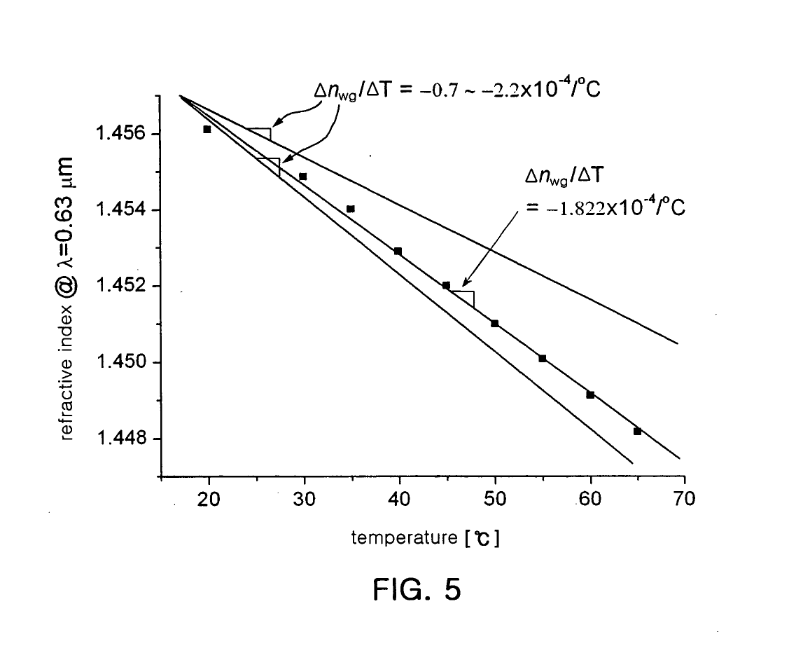

In the case where the semiconductor laser diode 31 consists of InP-based group III-V elements or group II-IV elements, it is known that the value of Δn_{LD}/ΔT, which is a variation rate (thermo-optical coefficient) of the refractive index of the semiconductor laser diode according to temperature variation of the semiconductor laser diode 31, is about 2.2×10⁻⁴/° C. Additionally, in the case where the waveguide structure 322 of the planar waveguide platform 32 consists of the polymeric material, the variation in effective refractive index of the polymeric material according to the temperature is illustrated in FIG. 5. As shown in FIG. 5, as the composition of the polymeric material constituting the waveguide structure is changed, the value of Δn_{wg}/ΔT, which is the variation rate (thermo-optical coefficient) of an effective refractive index of the polymeric material according to the temperature variation is in the range of about −0.7×10⁻⁴ to −2.2×10⁻⁴/° C. The waveguide structure 322 can be made of silica and the like, but in this case, since the temperature increase results in the increase of the effective refractive index of silica, silica is not appropriate for the present invention.

For example, assuming that the semiconductor laser diode 31 consist of InP-based group III-V elements and has a length of 600 μm, and the value of Δn_{wg}/ΔT, which is the variation rate (thermo-optical coefficient) of the effective refractive index of the polymeric material (the waveguide structure) according to the temperature variation, is −1.82×10⁻⁴/° C., the length of the optical waveguide from one side of the planar waveguide platform facing the light-emitting surface of the semiconductor laser diode to the thin film multi-layered reflection filter is −(2.2×10⁻⁴/−1.82×10⁻⁴)×600 μm, that is, 725 μm according to Equation 1.

As such, in accordance with the present invention, with the length and the thermo-optical coefficient of the semiconductor laser diode, and the thermo-optical coefficient of the polymeric material constituting the waveguide structure, it is possible to determine the length of the optical waveguide, which can be oscillated irrespective of the variation in external temperature, from one side of the planar waveguide platform facing the light-emitting surface of the semiconductor laser diode to the thin film multi-layered reflection filter.

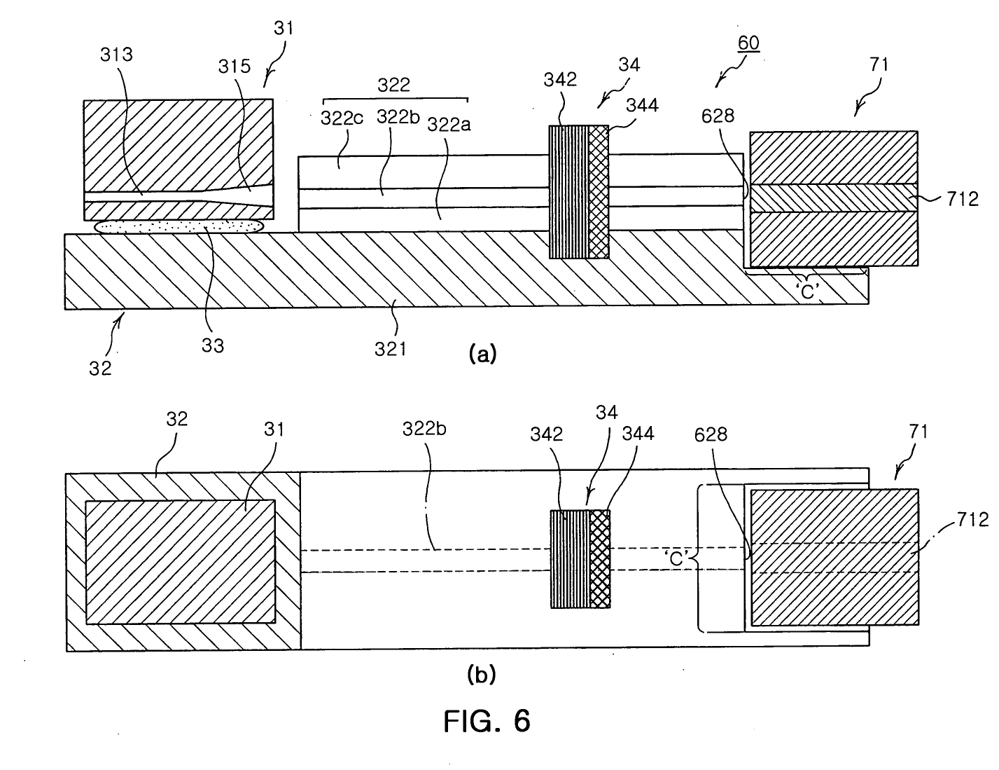

FIGS. 6a and 6b are a transverse sectional view and a cross-sectional view illustrating a temperature independent external cavity laser in accordance with another embodiment of the present invention. In the description with reference to FIGS. 6a and 6b, identical components substantially to those shown in FIG. 3 will be denoted by the same reference numerals to those of FIG. 3, and the detailed description thereof will be omitted.

Referring to FIGS. 6a and 6b, in the construction of a temperature independent external cavity laser 60 in accordance with another embodiment of the invention, a planar waveguide platform 32 has a groove for installing an optical fiber 71 formed on a predetermined region C opposite to the predetermined region A on which the semiconductor laser diode 31 is flip chip bonded. The groove may be formed to have a V-shaped cross section by removing some portions of a waveguide structure 322 of the planar waveguide platform 32 and the substrate 321. The groove may also have a vertical cross section 628 such that light transmitted from a core 322b of the waveguide structure 322 can be optically coupled to a core 712 of the optical fiber 71. As shown in FIG. 6a, the groove has a depth, which can allow the core 712 of the optical fiber 71 to be vertically aligned with the core 322b of the waveguide structure 322. Alternatively, as shown in FIG. 6b, the groove may be formed at a location where the core 712 of the optical fiber 71 is horizontally aligned with the core 322b of the waveguide structure 322. The optical fiber 71 may be fixed to the groove by means of thermosetting epoxy material or ultraviolet cured epoxy material.

The core 322b of the waveguide structure 322 may have a taper structure of which width is gradually varied in the vertical and horizontal directions as it approaches the cross section 628 facing the optical fiber.

As apparent from the above description, according to the present invention, the multi-layered thin film reflection film used as the reflection means for the external resonance is manufactured to have reflection characteristics not affected by the external temperature, thereby allowing the oscillation wavelength of the laser to be controlled without being affected by the external temperature, and reducing manufacturing costs.

Furthermore, according to the present invention, with the length and the thermo-optical coefficient of the semiconductor laser diode, and the thermo-optical coefficient of the polymeric material constituting the waveguide structure, it is possible to determine the length of the optical waveguide, which can be oscillated irrespective of variation in external temperature, without inserting additional silicon resin.

It should be understood that the embodiments and the accompanying drawings have been described for illustrative purposes and the present invention is limited by the following claims. Further, those skilled in the art will appreciate that various modifications, additions and substitutions are allowed without departing from the scope and spirit of the invention as set forth in the accompanying claims.

What is claimed is:

1. A temperature independent external cavity laser, comprising:
a semiconductor laser diode including an active region to generate light, and at least one light emitting surface to emit the light generated from the active region;
a planar waveguide platform including a substrate, a metallic pattern formed on a predetermined region of the substrate, a waveguide structure, and a trench portion formed in a predetermined region of the waveguide structure, the waveguide structure having a lower clad layer, a core, and an upper clad layer sequentially stacked in this order on a region of the substrate excluding the predetermined region formed of the metallic pattern, the trench portion having opposite side surfaces on which the core is exposed; and
a thin film multi-layered reflection filter disposed in the trench portion,
wherein the semiconductor laser diode is flip-chip bonded to the metallic pattern such that the light emitting surface faces one side surface of the waveguide structure.

2. The external cavity laser as set forth in claim 1, wherein the semiconductor laser diode further comprises an optical mode size converter between the active region and the light emission surface.

3. The external cavity laser as set forth in claim 1, wherein the semiconductor laser diode further comprises an antireflection film coated on one side of the light emission surface, and a high-reflection film formed on the other side of the light emission surface opposite to the antireflection film.

4. The external cavity laser as set forth in claim 1, wherein the waveguide structure consists of a polymeric material.

5. The external cavity laser as set forth in claim 1, wherein the thin film multi-layered reflection filter comprises a plurality of metal oxide films consisting of two types of metal oxide films and alternately stacked on a glass or polymer-based substrate, and has a variation rate of 3 pm/° C. or less at a central reflection wavelength according to variation in external temperature.

6. The external cavity laser as set forth in claim 5, wherein the metal oxide films consist of two types of metal oxide films selected from the groups consisting of SiO₂, Al₂O₃, Ta₂O₅ and TiO₂.

7. The external cavity laser as set forth in claim 5, wherein the glass or polymer-based substrate has a thickness of 50 μm or less.

8. The external cavity laser as set forth in claim 1, wherein the waveguide structure further has an epoxy material filled between side surfaces of the trench portion and the thin film multi-layered reflection filter, and the epoxy material is selected from the group consisting of a thermosetting epoxy material, an ultraviolet cured epoxy material, and the combination thereof.

9. The external cavity laser as set forth in claim 8, wherein the epoxy material has an effective refractive index within 0.1 of the effective refractive index of the core of the planar waveguide platform.

10. The external cavity laser as set forth in claim 1, wherein the waveguide structure has an optical waveguide from one side of the planar waveguide platform facing the light-emitting surface to the thin film multi-layered reflection filter, and the optical waveguide has a length determined according to the following Equation 1:
$${L}_{wg} = - \frac{( \frac{Δ {n}_{LD}}{Δ T} )}{( \frac{Δ {n}_{wg}}{Δ T} )} {L}_{LD} \qquad 1$$
In which L_{wg} is a length of the optical waveguide from the side of the planar waveguide platform facing the light-emitting surface to the thin film multi-layered reflection filter; Δn_{LD}/ΔT is a variation rate in refractive index of the semiconductor laser diode according to temperature variation; Δn_{wg}/ΔT is a variation rate in effective refractive index of the waveguide structure according to temperature variation; and L_{LD} is a length of the semiconductor laser diode.

11. The external cavity laser as set forth in claim 10, wherein the planar waveguide platform consists of the polymeric material, the Δn_{wg}/ΔT value of which is in the range of −0.7×10⁻⁴ to −2.2×10⁻⁴/° C.

12. The external cavity laser as set forth in claim 1, further comprising a groove formed on the other side opposite to one side of the planar waveguide platform facing the semiconductor laser diode to connect an optical fiber.
